(19) United States
(12) Patent Application Publication
(10) Pub. No.: US 2003/0061007 A1
(43) Pub. Date: Mar. 27, 2003

(54) Error condition processing in an automation system

(76) Inventor: Klaus Sigl, Feucht (DE)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/972,679

(22) Filed: Oct. 8, 2001

Related U.S. Application Data
(60) Provisional application No. 60/317,992, filed on Sep. 7, 2001.

(51) Int. Cl. G06F 15/00

(52) U.S. Cl. 702/185

(57) ABSTRACT

A method and system for analyzing fault conditions in an automation system. An error controller (10) connects to one or more machines or machine elements (12) in an automation system. Signals from the machine (12) are input to one or more inputs (14) of the error controller (10). Internal logic to the error controller (10) uses the inputs to identify possible error conditions, which are then transmitted to a central controller (16) via error controller outputs (18) of the error controller (10). A display monitor (20) provides a user interface for error analysis and configuration of the error controller (10). A PC (22) is provided for configuration of the error controller (10) by running suitable application software for the configuration thereof. When an error condition arises, corresponding error messages are extracted from a database and presented to a user via the display (20).

### BACKGROUND OF THE INVENTION

1. Field of the Invention

The invention relates to the field of automation systems. More specifically, it relates to identification and localization of error conditions generated therein.

2. Background of the Related Art

Since the time that Henry Ford of Ford Motor Company started implementing the concept of a production line, the manufacture of parts has increasingly involved the use of automation systems.

During the developmental cycle, manufactured parts are moved from one assembly and/or testing station to the subsequent stations by means of transport mechanisms such as conveyor belts, cranes, robotics system, and other transport means. A fault in any of these transport mechanisms can lead to costly delays not only in the production area involved but also by creating a bottleneck at the breakdown point that further results in a domino effect along the line. Ideally, the location and cause of a fault should be readily ascertainable in a minimal amount of time to reduce downtime. To this end, sensors are placed at various locations in automation systems for providing feedback to a central location. Simple logic relationships are defined relating the various sensor outputs to corresponding error conditions. However, these relationships are often expressed and presented in cryptic terms that require further interpretation by a technician, and thus do not provide a solution in real time.

One prior art error monitoring system provided by the assignee seeks to address some of the problems. The assignee provides a product known as SIMOCODE®-DP which is an electric motor protection and control device. SIMOCODE®-DP protects the motor against thermal overload by shorting the supply voltage to ground to avoid damage in the event of an overload condition. The SIMOCODE®-DP error controller analyzes the input signals obtained from the motor. Variables associated with the input signals of the product are used to define various status conditions, warnings, and errors. These variables are stored in a data storage medium in the form of an error look-up table that is accessible using application software to display the results on a display monitor. A help feature associated with the error table allows a technician to access additional information associated with the displayed variables.

The prior art, however, fails to take into account implementation of the fault monitoring and resolution of the overall system, e.g., the entire production line. For instance, in a production-line system, a detected error condition may display an error message “External Error 1.” The technician then typically has to identify a functional block associated with the error message “External Error 1.” He or she may further be required to identify a particular input associated with the functional block, e.g., a logic 0 signal on one of the inputs. To determine the source of the signal, he then has to review system documentation. Ultimately, he may localize the fault sufficiently to a particular sensor of the system, thus allowing the error to be addressed. Not only is this troubleshooting procedure time consuming, resulting in possible downtime for the plant, but it is also an arduous task requiring different documents to be reviewed in order to identify the source of the problem.

What is needed is a system that automatically reads, processes, interprets and presents to an operator fault information and corresponding fault resolution information to facilitate expeditious correction of any system faults.

### SUMMARY OF THE INVENTION

The invention disclosed and claimed herein, in one aspect thereof, provides a method of processing fault conditions in an automation system, which comprises identifying functional blocks making up the system, identifying potential error conditions associated with each of the functional blocks, defining possible causes for each of the error conditions, wherein a plurality of possible causes is defined for at least one of the error conditions, and developing error messages for the possible causes. Typically, the possible causes are defined based on external conditions that impact a functional block, and may require reviewing plant documentation. Preferably, each of a plurality of possible causes for an error condition is associated with a weighting factor defining the likelihood of an error condition having been caused by a particular one of the possible causes. Preferably, the error messages are associated with the potential errors through association in a database.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a block diagram of an automation system and a controller in accordance with the disclosed invention;

FIG. 2 illustrates a one embodiment of a database that associates the parameters for a particular piece of machinery in the form of error conditions, to error messages; and

FIG. 3 illustrates a flow chart of a process for developing and implementing the system, according to a disclosed embodiment.

### DETAILED DESCRIPTION OF THE INVENTION

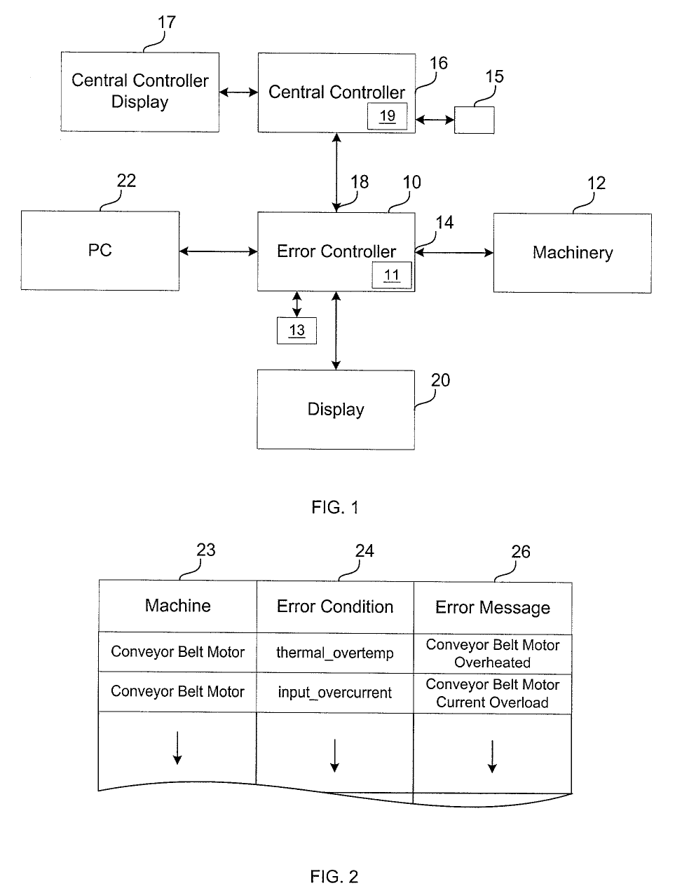

Referring now to FIG. 1, there is illustrated a block diagram that shows a system, in accordance with a disclosed embodiment. An error controller 10 is connected to one or more machines or machine elements 12 (hereafter referred to simply as machine or machines) in an automation system. Signals from the machine 12 serve as input signals to one or more inputs 14 of the error controller 10. Internal logic to the error controller 10 uses the inputs to identify possible error conditions. As discussed in greater detail hereinbelow, the error conditions are transmitted to a central controller 16 from error controller outputs 18 of the error controller 10. The system of FIG. 1 also includes a display monitor 20 which may be used for error analysis and is used in the configuration of the error controller 10. In another embodiment, the display 20 may be used purely for configuration purposes. In such an embodiment the error analysis is handled from the central controller that will have its central controller display 17. Configuration of the error controller 10 is achieved through the use of an external controller such as a PC 22 running suitable application software such as Win-SIMOCODE.

The implementation of an error control system in a production plant or other automation system involves identifying the various machines 12 in the automation system. A separate error controller 10 can be associated with each such machine 12. Alternatively, one or more error controllers 10 may serve a number of machines 12. Parameter values are identified for each machine 12. For example, a conveyor belt motor may have an overload parameter, a thermal overheating parameter, a current input oversupply parameter. Thus the parameters for a machine 12 correspond to the various error conditions associated with the machine 12 that could conceivable arise. Using the PC 22, the error controller 10 is configured with these parameters. In one embodiment, the controller 10 includes an RS-232 interface to configure it for the particular machine element. The parameters are ascribed, in much the same way as is done for a SIMOCODE®-DP controller, by means of Win-SIMOCODE-DP application software running on the PC 22. In one embodiment, the output 18 of the error controller 10 is suitably communicated utilizing a PROFIBUS®-DP protocol for communicating signals between the error controller 10 and the central controller 16.

In order to ensure that application-specific conditions are taken into account, the invention further requires during the project phase, that plant documentation be analyzed to identify all external conditions that impact the parameters associated with a machine 12. Thus, each error condition or fault condition is tracked down to its root cause. Error messages are then devised and assigned to each error condition. In this way, the various error conditions associated with a machine element 12 are associated with error messages that are understandable by a user and that clearly define the root cause of a fault. Thus associations of the machine 12, error conditions, and error messages are contained in a parameter data file.

Referring now to FIG. 2, there is illustrated the parameters or error conditions and associated error messages as stored in the form of a data table in a database. FIG. 2 shows a sample database structure having a machine type in a first column 23, a list of error conditions that correspond to the machine type in a second column 24, and a third column 26 providing the corresponding error message that is assigned to the error condition o that particular machine. The database serves as a look-up table to either automatically provide detailed error messages to a user or to form the basis of a help feature that is accessible by a user when an error condition arises.

It will be appreciated that the database of parameter data files relating the machine 12, and error conditions to the error messages may be stored internal to the error controller 10 in a memory 11 or external in a storage unit 13. Note that memory 11 and the storage unit 13 are suitable for accommodating the database, and where necessary, are non-volatile such that the database information is retained under loss-of-power or power fluctuation conditions. Instead, the database may be stored in a separate memory device, with the error controller 10 simply supplying the error condition which is then used to extract the corresponding error message from the separately stored database. Further, the parameter data file database may be stored local to the central controller 16 in an internal storage 19 comprising, for example, a non-volatile memory. Additionally, the database of files may be stored external to the central controller in a storage until 15 for access thereto. Where the parameter database (in either or both storage 19 or storage 15) is local to the central controller 16, the error controller 10 can then provide only the error condition to the central controller 16 such the central controller accesses the parameter database to obtain the corresponding error message. Such an implementation is useful for legacy error controller systems that are incapable of providing error condition/message resolution from a database.

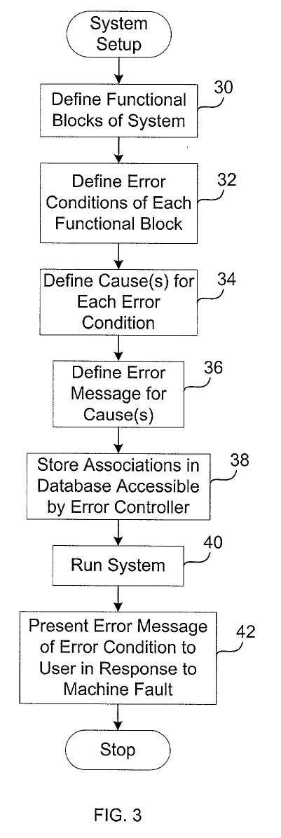

Referring now to FIG. 3, there is illustrated a flow chart of the process for configuring and implementing the system, in accordance with a disclosed embodiment. Flow begins at a function block 30 where the system is segmented into functional blocks to which error conditions and error messages will be assigned. Error conditions are then defined for each functional block, as indicated in flow to a function block 32. One or more causes for each error condition are then defined, as indicated in flow to a function block 34. Flow is then to a function block 36 where error messages that are displayed or presented to a user, are developed. The error messages are designed to be informative to the user in that the user does not need to reference a conversion chart or similar reference to understand the nature and source of the error condition.

Once all of the associations for the machine, error conditions, and error messages have been defined and developed, flow is to a function block 38 where the associations are stored in a database that is accessible and readable by the error controller 10. As mentioned hereinabove, the associations of the machine, error conditions, and error messages are developed on the PC 22, and when complete, communicated to the database associated with the error controller for future access by the error controller 10.

Once the system is brought on-line, as indicated in a function block 40, any fault occurring in the machine 12 is input to the error controller 10 wherein the database is accessed. The machine 12 outputs a machine signal to the error controller 10 that is interpretable by the error controller 10 as coming from that particular machine 12. Further, the machine signal includes an error condition that when compared against the database, returns a corresponding error message extracted from the database that is presented to the technician or operator, as indicated in a function block 42. The process of displaying the error message is accomplished by the error controller 10 to the display 20. Alternatively, the central controller 16 receives the error message from the error controller 10 via a communication bus compatible with output 18 such that the central controller 16 presents the error messages to a user via the central controller display 17. Note that the error message may optionally be displayed under control of the error controller to the central controller display 17. The user or technician can then more readily ascertain the cause and source of the fault condition, and expedite a safe shutdown and/or repair of the system, if such an action is required.

It is appreciated that display of the error messages can be accomplished over a conventional packet-switched network such that the central controller 16 communicates the error messages over the network to a remote display of the technician at a location remote from the site of the system. For example, the network can be a global communication network, e.g., the Internet, such that the technician monitors the system from a control room located geographically remote from the system or system being monitored.

Alternatively, the error messages can be presented audibly instead of, or in conjunction with, display thereof utilizing conventional signal conversion technology. The technician can then hear the error message when announced, and react accordingly.

Alternatively still, the error message can be converted for communication to the technician via a wireless device, e.g., a pager, such that the technician can view text of the error message from the wireless device at remote location.

The present invention has been described with reference to a particular sample system, and a certain nomenclature was adopted to define the various components, signals and conditions. It will be appreciated that different embodiments could be created without departing from the essence of the invention as claimed in the attached claims.

What is claimed is:

1. A method of monitoring an automation system, comprising
identifying functional blocks making up the system;
identifying potential error conditions associated with each of said functional blocks;
defining possible causes for each of said potential error conditions wherein a plurality of possible causes is defined for at least one of said error conditions; and
developing corresponding error messages for the possible causes.

2. The method of claim 1, wherein said possible causes are defined in the step of defining based upon external conditions that impact a functional block.

3. The method of claim 2, wherein said possible causes are defined in the step of defining by reviewing plant documentation associated with said functional blocks.

4. The method of claim 2, wherein each of a plurality of possible causes for an error condition is associated with a weighting factor defining the likelihood of an error condition having been caused by said possible cause.

5. The method of claim 1, wherein said error messages are associated with said potential error conditions that are stored in a database.
